(19) United States
(12) Patent Application Publication
(10) Pub. No.: US 2015/0115197 A1
(43) Pub. Date: Apr. 30, 2015

(54) DUST SUPPRESSION COMPOSITION AND METHOD

(71) Applicant: Natural Alternatives, LLC, Lexington, KY (US)

(72) Inventor: Todd Bloomer, Lexington, KY (US)

(73) Assignee: Natural Alternatives, LLC, Lexington, KY (US)

(21) Appl. No.: 14/064,635

(22) Filed: Oct. 28, 2013

(51) Int. Cl. C09K 3/22; B65G 67/04

(52) U.S. Cl. CPC C09K 3/22; B65G 67/04
USPC 252/88.1; 414/800

(57) ABSTRACT

A dust suppression composition includes a combination of a crusting agent, a dust suppression agent and a carrier. A method of suppressing dust of an aggregate material includes the step of contacting aggregate material with an effective amount of that dust suppression composition.

### TECHNICAL FIELD

This document relates generally the field of dust suppression and, more particularly, to dust suppression of aggregate materials such as coal and the like.

### BACKGROUND

Dust suppression as defined herein relates to preventing or reducing the extent to which fine particulates from aggregate materials become airborne or suspended in air. Such fine particulates or dust may be generated in significant quantities during the handling, transporting and storing of a number of aggregate materials including, but not limited to coal, rock, ore, taconite, sulfur, copper, limestone, gypsum, fly ash, cement, bauxite, ash, sinter, fertilizer, phosphate, clay and other finely divided ores and minerals. In-transit dust suppression is a particular concern. More specifically, the aggregate material is subjected to abrasion during loading which tends to produce dust. That dust is then subjected to wind speeds of up to fifty miles per hour or more during transit in a truck or coal hopper rail car.

In order to suppress this in-transit dust, it is generally accepted practice to first load the aggregate material into the truck or hopper car and then spray the exposed surface of the aggregate material with a dust suppression composition. That dust suppression composition must form a pliable crust that moves with the aggregate material as it settles in the truck or hopper car during transit. This pliability allows the dust suppression composition to maintain integrity and better seal in the dust. In contrast, a composition that forms a brittle crust is prone to cracking during movement of the aggregate material. When this occurs, the integrity of the crust is lost and dust escapes into the airstream flowing over the material.

This document relates to a new and improved dust suppression composition and method of suppressing dust from an aggregate material. The new composition displays excellent handling properties and may be conveniently applied by spray or other means to fully cover the aggregate material with a pliable crust and essentially seal in fine dust particulates thereby preventing them from being entrained in the air passing over the material when in transport in an open rail car or truck. Advantageously, the composition is also characterized by anti-freezing and deicing properties. This allows it to remain a liquid at relatively low temperatures so that it may be applied by spray and provides a pliable crust even under some winter conditions. Further, the composition also effectively resists or prevents the aggregate material from sticking together due to freezing temperatures thereby improving its handling characteristics. As a result, the aggregate material remains free flowing for quick and efficient removal from the transport vehicle at the unloading destination even at temperatures below freezing.

### SUMMARY

In accordance with the purposes set forth herein a dust suppression composition is provided. The dust suppression composition may be generally described as comprising a combination of (a) a crusting agent, (b) a dust suppression agent and (c) a carrier. The composition includes between about 6 and about 90 weight percent of the crusting agent, about 10 and about 90 weight percent of the dust suppression agent and between about 10 and about 75 weight percent of the carrier. In one particularly useful embodiment, the composition includes between about 50 and about 55 weight percent crusting agent, between about 20 and about 55 weight percent dust suppression agent and between about 10 and about 30 weight percent carrier. In one possible embodiment, the crusting agent is desugared sugar beet molasses having 50-85% suspended solids. Typically the dust suppression agent is selected from a group consisting of a lignosulfonate, tall oil, a polyacrylamide, a latex polymer and mixtures thereof. Typically the carrier is water.

In one possible embodiment the dust suppression composition includes between 50 and 55 weight percent of the crusting agent, 20 and 30 weight percent latex polymer dust suppression agent and 15 and 30 weight percent of a carrier.

In yet another possible embodiment the composition includes between about 50 and about 55 weight percent of the crusting agent, between about 20 and about 30 weight percent lignosulfonate dust suppression agent and between about 15 and about 30 weight percent of a carrier.

In accordance with another aspect, a method is provided for suppressing dust from an aggregate material. That method may be broadly described as comprising the step of contacting the aggregate material with an effective amount of a dust suppression composition including (a) a crusting agent, (b) a dust suppression agent and (c) a carrier. Still further, the method may include applying the dust suppression composition to the aggregate material which may be selected from a group of materials consisting of, for example, coal, rock, ore, taconite, sulfur, copper, limestone, gypsum, fly ash, cement, bauxite, ash, sinter, fertilizer, phosphate, clay and other finely divided ores and minerals.

The dust suppression composition may be applied to the aggregate material prior to loading into a railroad hopper car or truck. In another embodiment the dust suppression composition is applied to the aggregate material during loading into a railroad hopper car or truck. In yet another embodiment the dust suppression composition is applied to the aggregate material following loading into a railroad hopper car or truck. In any embodiment the dust suppression composition may be applied at a rate of between about 0.1 and about 5.0 gallons per ton of aggregate material. In another embodiment the dust suppression composition is applied at a rate of between about 0.1 and about 1.5 gallons per ton of aggregate material.

These and other embodiments will be set forth in the description which follows.

### DETAILED DESCRIPTION

A dust suppression composition may be generally described as comprising a combination of (a) a crusting agent, (b) a dust suppression agent (different from the fermentation process material) and (c) a carrier. In one possible embodiment the composition includes between about 6 and about 90 weight percent of the crusting agent, between about 10 and about 90 weight percent of the dust suppression agent and between about 10 and about 75 weight percent of the carrier. In one possible embodiment the composition includes between about 50 to 55 weight percent crusting agent, between about 20 to 55 weight percent dust suppression agent and between about 10 to 30 weight percent carrier. In yet another possible embodiment, the composition includes between about 20 and about 60 weight percent crusting agent, between about 20 and about 60 weight percent dust suppression agent and between about 10 and about 60 weight percent carrier.

Stated another way, the dust suppression composition comprises between 1 and 3 parts by volume of a crusting agent and between 1 and 3 parts by volume of a dust suppression agent. In one embodiment, the composition includes one part by volume crusting agent and one part by volume dust suppression agent. In any of the possible embodiments, the crusting agent may be selected from a group including, but not necessarily limited to a material from a fermentation process for producing an amino acid from a carbohydrate source, condensed molasses fermentation solubles, cassava, raw sugar, processed sugar, starch, starch hydrolysate, soybean sugar, soybean molasses, desugared soybean molasses, molasses, desugared molasses, corn sugar molasses, sugar beet molasses, sugar cane molasses, desugared sugar beet molasses and mixtures thereof. These materials have the desired consistency and properties to form a pliable crust over aggregate material capable of maintaining its integrity as the material moves and settles during transport. Thus, the dust suppression composition provides enhanced suppression of aggregate material dust.

In one possible embodiment the crusting agent is a fermentation process material that includes 50-85% suspended solids while the dust suppression agent includes 5-50% suspended solids. The carrier in these suspended solids materials is water.

The fermentation process that produces the material relies upon the use of microbes that synthesize the desired amino acid from the carbohydrate source. The microbes may be genetically altered to better perform this function and include bacteria from various genera. In one particularly useful embodiment of the present invention, the amino acid is selected from a group consisting of glutamic acid and lysine.

Glutamic acid may be produced by bacteria such as Bacillus micrococcus, Brevibacterium microbacterium, Corynebacterium anthrobacter and the like. Corynebacterium glutamicum and related strains are useful in producing lysine. It should be appreciated, however, that other microorganisms useful in producing glutamic acid or lysine by means of fermentation of a carbohydrate source may be used.

The carbohydrate source may be any such source known to be useful in the production of the desired amino acid by means of microbial fermentation. Carbohydrate sources include, but are not limited to, cassava, raw sugar, processed sugar, starch, starch hydrolysate, soybean sugar, soybean molasses, desugared soybean molasses, molasses, desugared molasses, corn sugar molasses, sugar beet molasses, sugar cane molasses, desugared sugar beet molasses and mixtures thereof.

In one possible production process known in the art, a starch from cassava is hydrolized. After the starch processing stage, molasses is added during a syrup refining stage. After this stage, glucose syrup is added and the mixture proceeds to a fermentation stage.

During the fermentation stage, ammonia and micro-organisms, in this case bacteria, are added for microbial fermentation. The bacteria are grown in a liquid medium containing molasses as the fermentation substrate. Glutamic acid producing bacteria produce and excrete glutamic acid into the medium. Alternatively or in addition, lysine producing bacteria may be used to produce and excrete lysine into the medium. As a consequence of fermentation, all or substantially all of the sugar in the substrate is used.

Subsequently, the glutamic acid/lysine is separated from the medium by evaporation and neutralization (addition of sodium hydroxide and hydrochloric acid). The glutamic acid/lysine then goes through another stage of neutralization, followed by filtration and crystallization. The glutamic acid/lysine is then dried, sieved and packaged. The leftover byproduct or waste material from the fermentation process, sometimes referred to as condensed molasses fermentation solubles (CMS), may be used as an active ingredient in the current dust suppression composition.

In addition to having excellent dust suppression properties, the material of the fermentation process also exhibits enhanced deicing properties and is non-corrosive. The material is approximately sixty percent (60%) solids, but may vary depending on the process. The carrier is typically water although any other appropriate carrier suitable for use in a dust suppression composition including fermentation material may be used. In one particularly useful embodiment the fermentation process waste material is desugared sugared beet molasses having between about 50-85% suspended solids.

The dust suppression agent may be selected from any dust suppression agent known in the art that is appropriate for use in a dust suppression composition including fermentation material, including fermentation waste material. Useful dust suppression agents include but are not limited to lignosulfonate, tall oil, a polyacrylamide, polyDADMAC polymer, latex polymer and mixtures thereof. For purposes of this document “latex polymer” includes natural and synthetic latex materials. This includes latex materials made by emulsion polymerization techniques from styrene-butadiene copolymer, acrylate resins, polyvinyl acetate and similar materials. This also includes recycled materials such as latex paint.

One possible embodiment includes between about 50 and about 55 weight percent of the crusting agent, between about 20 and about 30 weight percent of latex polymer dust suppression agent and between about 15 and about 30 weight percent carrier. Another possible embodiment includes between about 50 and about 55 weight percent of the crusting agent, between about 20 and about 30 weight percent lignosulfonate dust suppression agent and between about 15 and about 30 weight percent carrier. In any of the embodiments the lignosulfonate dust suppression agent may, for example, be selected from a group consisting of sodium lignosulfonate, calcium lignosulfonate, ammonium lignosulfonate and mixtures thereof.

The dust suppression composition may also include other additives including, but not limited to, emulsifiers and surfactants. Surfactants useful in the present composition include both anionic and nonionic surfactants. Specific emulsifiers and surfactants useful in the composition include, but are not limited to, detergents, sodium stearoyl lactylate, emulsifying wax, dish washing liquid, polyethylene glycol ethers, alcohol ethoxylates, phosphate ester-containing surfactants and mixtures thereof.

A method of suppressing dust from an aggregate material may be broadly described as comprising the step of contacting the aggregate material with an effective amount of a dust suppression composition including (a) a crusting agent, as described in detail above, (b) a dust suppression agent and (c) a carrier. More specifically this includes applying the dust suppression composition to the aggregate material. That aggregate material may be substantially any aggregate material prone to the production of dust and wind erosion during transportation and/or storage. Such aggregate materials include, but are not limited to, coal, rock, ore, taconite, sulfur, copper, limestone, gypsum, fly ash, cement, bauxite, ash, sinter, fertilizer, phosphate, clay and other finely divided ores and minerals.

The dust suppression composition may be applied to the aggregate material prior to loading into a rail hopper car or truck. In another possible embodiment the dust suppression composition may be applied to the aggregate material during loading into the railroad hopper car or truck. In yet another possible embodiment the dust suppression composition may be applied to the aggregate material following loading into a railroad hopper car or truck. Advantageously, the dust suppression composition has anti-freezing and de-icing properties. As a result it is freeze resistant thereby allowing it to remain in liquid form for simple and convenient spray application under all except for the harshest winter conditions. These properties also help maintain a pliable crust. Further, once applied it prevents the aggregate material from freezing together thereby maintaining free flowing properties so that the aggregate material may be easily dumped from a transport vehicle upon reaching its desired destination even when temperatures are below freezing. Thus, in winter weather it is very desirable to apply the dust suppression composition to the aggregate material prior to or during loading into a railroad hopper car or truck so that all the material is covered with the dust suppression agent. In this way the material is maintained free flowing throughout the entire volume of the aggregate material loaded into the hopper car or truck. For such an application the dust suppression composition may be applied at a rate of between about 0.1 and about 5.0 gallons per ton of aggregate material. In another possible embodiment the dust suppression composition may be applied at a rate of between about 0.1 and about 1.5 gallons per ton of aggregate material. In another embodiment between 3 to 65 gallons of dust suppression composition is applied over the top of aggregate material contained in a truck or railcar. This ensures the formation of a pliable crust over the top of the aggregate material to seal in and thereby suppress airborne dust during transit.

Significantly, it should be appreciated that the primary component of the dust suppression composition is an organic fermentation process material that, advantageously, is non-corrosive and environmentally friendly. Further it will not interfere with the use of the aggregate coal as fuel for a coal fired boiler. Thus, it does not need to be removed from aggregate coal prior to us.

The following examples illustrate various possible dust suppression compositions consistent with the teachings of this document. Of course, these examples are provided for purposes of illustration only and are not intended to be limiting in scope.

### EXAMPLE 1

Desugared sugar beet molasses having 50% suspended solids is blended with a latex material having 10% suspended solids at a ratio of 1:1 by volume.

### EXAMPLE 2

Sugar cane molasses having 50% suspended solids is blended with a latex material having 10% suspended solids at a ratio of 1:1 by volume.

### EXAMPLE 3

Desugared sugar beet molasses having 70% suspended solids is blended with a tall oil emulsion having 15% suspended solids at a ratio of 1:1 by volume.

### EXAMPLE 4

Desugared sugar beet molasses having 50% suspended solids is blended with calcium lignosulfonate having 40% suspended solids at a ratio of 1:1 by volume.

### EXAMPLE 5

Soybean molasses having 55% suspended solids is blended with a latex material having 10% suspended solids at a ratio of 1:1 by volume.

The carrier in all of the suspended solids materials in example 1-5 is water.

The foregoing has been presented for purposes of illustration and description. It is not intended to be exhaustive or to limit the dust suppression composition to the precise form or embodiments disclosed. Obvious modifications and variations are possible in light of the above teachings. All such modifications and variations are within the scope of the appended claims when interpreted in accordance with the breadth to which they are fairly, legally and equitably entitled.

What is claimed:

1. A dust suppression composition, comprising:
a combination of (a) a crusting agent, (b) a dust suppression agent and (c) a carrier.

2. The composition of claim 1 wherein said crusting agent is selected from a group consisting of a material from a fermentation process for producing an amino acid from a carbohydrate source, condensed molasses fermentation solubles, cassava, raw sugar, processed sugar, starch, starch hydrolysate, soybean sugar, soybean molasses, desugared soybean molasses, molasses, desugared molasses, corn sugar molasses, sugar beet molasses, sugar cane molasses, desugared sugar beet molasses and mixtures thereof.

3. The composition of claim 2 including between about 6 and about 90 weight percent of said crusting agent, about 10 and about 90 weight percent of said dust suppression agent and between about 10 and about 75 weight percent of said carrier.

4. The composition of claim 2 including between about 50 and about 55 weight percent of said crusting agent, about 20 and about 55 weight percent of said dust suppression agent and between about 10 and about 30 weight percent of said carrier.

5. The composition of claim 2 including between about 20 and about 60 weight percent of said crusting agent, about 20 and about 60 weight percent of said dust suppression agent and between about 10 and about 60 weight percent of said carrier.

6. The composition of claim 2, wherein said crusting agent is desugared sugar beet molasses having 50-85% suspended solids.

7. The composition of claim 6, wherein said dust suppression agent is selected from a group consisting of a lignosulfonate, tall oil, a polyacrylamide, polyDADMAC polymer, a latex polymer and mixtures thereof.

8. The composition of claim 7, wherein said carrier is water.

9. The composition of claim 2, wherein said dust suppression agent is selected from a group consisting of a lignosulfonate, tall oil, a polyacrylamide, polyDADMAC polymer, a latex polymer and mixtures thereof.

10. The composition of claim 2, wherein said carrier is water.

11. The composition of claim 1 including between 50 and 55 weight percent of said crusting agent, 20 and 30 weight percent latex polymer dust suppression agent and 15 and 30 weight percent carrier.

12. The composition of claim 11 wherein said carrier is water.

13. The composition of claim 2, including between 50 and 55 weight percent of said fermentation process material, 20 and 30 weight percent lignosulfonate dust suppression agent and 15 and 30 weight percent carrier.

14. The composition of claim 13, wherein said lignosulfonate dust suppression agent is selected from a group consisting of sodium lignosulfonate, calcium lignosulfonate, ammonium lignosulfonate and mixtures thereof.

15. The composition of claim 1 wherein said crusting agent is soybean sugar.

16. The composition of claim 1 wherein said crusting agent is desugared sugar beet molasses.

17. The composition of claim 1 wherein said crusting agent is sugar cane molassses.

18. A method of suppressing dust from an aggregate material, comprising:
contacting said aggregate material with an effective amount of a dust suppression composition including (a) a crusting agent, (b) a dust suppression agent and (c) a carrier.

19. The method of claim 18 including using a crusting agent selected from a group consisting of a material from a fermentation process for producing an amino acid from a carbohydrate source, condensed molasses fermentation solubles, cassava, raw sugar, processed sugar, starch, starch hydrolysate, soybean sugar, soybean molasses, desugared soybean molasses, molasses, desugared molasses, corn sugar molasses, sugar beet molasses, sugar cane molasses, desugared sugar beet molasses and mixtures thereof.

20. The method of claim 19, including applying said dust suppression composition to said aggregate material selected from a group consisting of coal, rock, ore, taconite, sulfur, copper, limestone, gypsum, fly ash, cement, bauxite, ash, sinter, fertilizer, phosphate, clay and other finely divided ores and minerals.

21. The method of claim 19 including applying said dust suppression composition to aggregate material prior to loading into a railroad hopper car or truck.

22. The method of claim 19 including applying said dust suppression composition to aggregate material during loading into a railroad hopper car or truck.

23. The method of claim 19, including applying said dust suppression composition to aggregate material following loading into a railroad hopper car or truck.

24. The method of claim 19, including applying said dust suppression composition at a rate of between about 0.1 and about 5.0 gallons per ton of aggregate material.

25. The method of claim 19, including applying said dust suppression composition at a rate of between about 0.1 and about 1.5 gallons per ton of aggregate material.

26. The method of claim 19 including applying said dust suppression composition at a rate of between 3 to 65 gallons over an exposed surface of aggregate material in a trick or railroad hopper car.

27. A dust suppression composition comprising:
between 1 and 3 parts by volume of a crusting agent; and
between 1 and 3 parts by volume of a dust suppression agent.

28. The composition of claim 27 including 1 part by volume crusting agent having between 50 and 85% suspended solids and 1 part by volume dust suppression agent having between 5 and 50% suspended solids.

29. The composition of claim 27 wherein said crusting agent is selected from a group consisting of a material from a fermentation process for producing an amino acid from a carbohydrate source, condensed molasses fermentation solubles, cassava, raw sugar, processed sugar, starch, starch hydrolysate, soybean sugar, soybean molasses, desugared soybean molasses, molasses, desugared molasses, corn sugar molasses, sugar beet molasses, sugar cane molasses, desugared sugar beet molasses and mixtures thereof.

30. The composition of claim 29, wherein said dust suppression agent is selected from a group consisting of a lignosulfonate, tall oil, a polyacrylamide, polyDADMAC polymer, a latex polymer and mixtures thereof.
